(19) United States
(12) Patent Application Publication
(10) Pub. No.: US 2006/0240800 A1
(43) Pub. Date: Oct. 26, 2006

(54) Wireless appliance alert notification system

(76) Inventor: Vincent Gerald Bannan, Westmont, NJ (US)

Correspondence Address: Vincent G. Bannan, 1111 Oriental Ave, Westmont, NJ, 08108, US

(21) Appl. No.: 11/110,196

(22) Filed: Apr. 21, 2005

(51) Int. Cl. H04M 11/04

(52) U.S. Cl. 455/344

(57) ABSTRACT

A method for wireless notifications that an electrical appliance is plugged in and ‘on’. The system architecture consists of one or more transmitters and a receiver. The method for implementation for this invention is as follows: Transmitters are plugged into 110V outlets. Electrical appliances that are normally plugged in to 110V outlets are now plugged in to the invention transmitter. When the appliance is turned on, a wireless signal is sent to the invention remote receiver indicating this fact. The invention receiver, upon receiving this signal turns on the corresponding alert light for that transmitter. When the appliance is unplugged from the invention transmitter, or turned off, a signal is sent to the invention receiver. When the invention receiver receives this signal, the alarm light for that transmitter is turned off. Users of this system will be able to quickly and conveniently check that appliances are on or off by simply looking at the receiver. The inventions receiver can double as a key chain lending to the convenience of checking appliances before leaving the house. The invention consists of multiple transmitters each having a unique indicator light on the invention receiver.

### FIELD OF THE INVENTION

The present invention relates to a device that alerts users that electrical appliances are plugged in and ‘on’.

### BACKGROUND OF THE INVENTION

Electrical appliances are used in virtually every household throughout the United States. A common occurrence in these households is forgetting to unplug or turn off an appliance before leaving the house. Even if you remember to turn off the appliance you sometimes forget that they did and question yourself the entire time you are away.

There are appliances on the market that have timers built in to them and will shut off after x number of minutes, but they do not provide remote notification and they are restricted to the specific device.

Forgetting to turn of an appliance leads to unnecessary wear on the appliance, wasted electricity and can sometimes lead to fire.

With this invention the homeowner will be able to easily see that they have or have not turned off an appliance that was plugged in to the invention transmitter. If they choose to use the inventions receiver as a key ring they will be able to see what devices are on each time they pick up their keys. This will assist them in checking appliances before leaving the house.

The optional audible alarm serves as an added reminder that there is an appliance plugged in to the inventions transmitter somewhere in the house.

Since the inventions receiver contains a battery to power the indicator lights, users will be able to check the status of appliances monitored by the invention after leaving the house. This allows you to double check when you are away from home that you did (or didn't) turn off all appliances plugged in to the inventions transmitter. The receivers alert light will remain on even after leaving the house.

It is therefore an object of the invention to alert the users of the status of devices plugged in to the inventions transmitter(s) simply by looking at the inventions receiver. This is especially useful to prevent people from leaving the house when an appliance is plugged in and on.

It is another object of the invention to remind users through an audible alert to turn off devices plugged in to the inventions transmitter.

### SUMMARY OF THE INVENTION

The present invention is a system comprising of one or more transmitters that are approximately 4″ W * 3″ H and 1″ deep and plug in to an 110V outlet, and one receiver that is approximately 2″ H * 1″ W and 0.25″ deep and resembles an automobile remote keyless entry device.

The transmitters are plugged in to typical 110V household outlets. The inventions transmitters contain two (2) 110V receptacles on the face that can be used to plug in electrical appliances that will be monitored by the invention. The transmitters send a wireless signal to the receiver indicating the status of the device that is plugged in to the transmitter. When the device is turned on, the transmitter sends a signal to the receiver to turn on the corresponding light for that transmitter. The signal is sent every two minutes as long as the appliance is plugged in to allow for proper notification in case the receiver had been out of range. When the device is turned off (or unplugged) the transmitter sends a signal to the receiver to turn off the light. This signal is also sent every two minutes to allow for proper notification in case the receiver had been out of range.

The inventions receiver also contains a key ring so that keys can be attached to the unit. Doing so provides the added protection of recognizing the status of devices being monitored by the invention as they pick up their keys to leave the house.

This provides a piece of mind when leaving the house and prevents the second-guessing that most of us have about whether or not they turned off an appliance.

Even more important then the piece of mind this invention can provide is the safety aspect of alerting homeowners that an appliance is plugged in and on, even before they leave the house. If a homeowner hangs their keys from the receivers key ring they will notice the indicator lights as they grab their keys and be able to turn off appliances plugged in to the inventions transmitter that are still on before they leave.

If a person is of a forgetful nature, this inventions audible alarm can remind them that they have plugged in a device to the inventions transmitter that is still on. Most of us know people that are forever plugging in a device to warm it up and then go off and do other things forgetting to get back to the device they turned on to warm up. If they plugged the device in to the inventions transmitter, an audible alarm would periodically sound much in the same way your cell phone reminds you that you missed a call or have a voice mail message.

### BRIEF DESCRIPTION OF THE DRAWINGS

A complete understanding of the present invention may be obtained by reference to the accompanying drawings, when considered in conjunction with the subsequent, detailed description, in which:

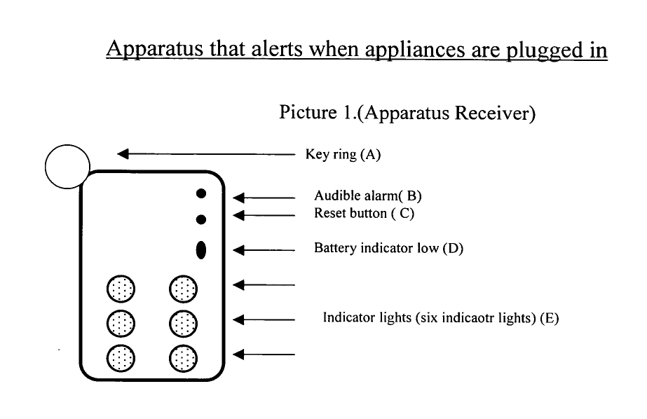

FIG. 1 is a front view of an Inventions receiver;
A—There is a key ring that allows users to attach car keys and house keys to the receiver
B—There is an audible alarm that notifies users when there is an active appliance plugged in to any of the six transmitters.
C—There is a reset button that will reset all alarms and lights to the off status.
D—There is a battery low light to indicate when the receivers battery is low.
E—The receiver contains 6 alert lights that represent up to six invention transmitters. Each light represents a specific transmitter and is turned on or off based on the state of the appliance plugged in to that transmitter.

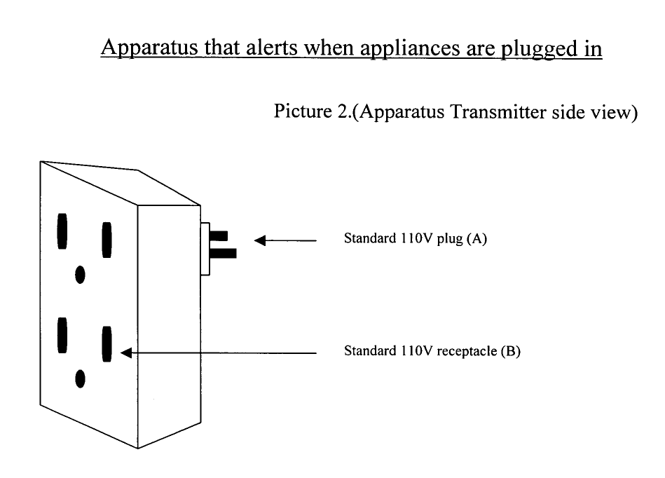

FIG. 2 is a side view of an Inventions transmitter;
A—The transmitter plug to be used to plug the transmitter in to any 110V outlet
B—Two 110V receptacles to be used to plug appliances to be monitored by the invention.

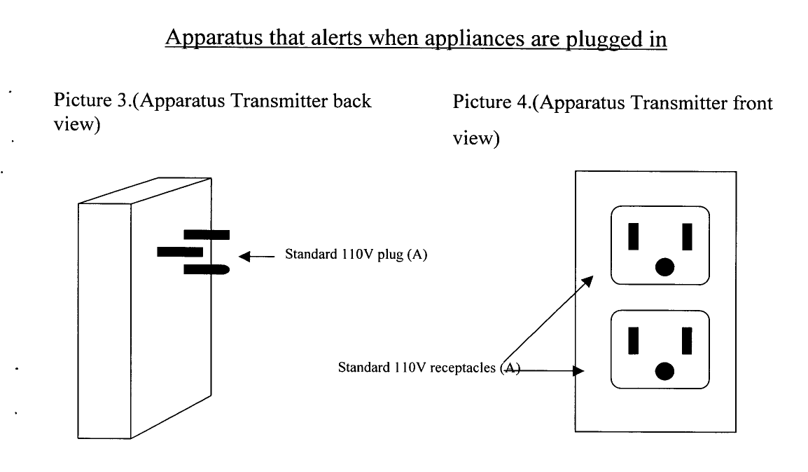

FIG. 3 is a rear view of an Inventions transmitter; and
A—The transmitter plug to be used to plug the transmitter in to any 110V outlet

FIG. 4 is a front view of an Inventions transmitter.
A—Two 110V receptacles to be used to plug appliances to be monitored by the invention.

### DESCRIPTION OF THE PREFERRED EMBODIMENT

The Wireless Alert System is designed to alert users of the system that an appliance plugged in to the invention is on. It is the object of the invention to alert users of this fact so they do not inadvertently leave appliances on. The invention addresses both a resource and a safety concern.

The Wireless Appliance Alert system is made up of a single receiver that is approximately 2″ H * 1″ W and 0.25″ deep and resembles an automobile remote keyless entry device and multiple transmitters. There can be up to six transmitters per system.

The receiver processes a wireless signal sent from one of the inventions transmitters and turns on or off the corresponding alert light (Picture 1.E) on the receivers face. When an appliance is plugged in to one of the transmitters and turned on, a wireless signal is sent to the receiver and that transmitters light is switched on. The signal from each transmitter is unique as it contains the identification of the transmitter. This is how the receiver determines which light to turn on or off. When the appliance is unplugged or turned off, another signal is sent to the receiver and that transmitters light is turned off. By simply looking at the receiver, the user can tell if any appliance is being monitored by the invention are on.

The receiver also allows an optional audible alert when there is an appliance plugged in to any of the transmitters and on (Picture 1.A). This allows the system to monitor and alert the user that at least one appliance being monitored by the system is on. This notification is similar to your cell phone alerting you that you have a message or missed a call. The alert will beep every five minutes as long as there is an appliance plugged in to the system. The audible alert simply monitors the lights on the receiver and beeps as long as one light is on. There is a button on the face of the receiver to toggle the audible alarm on and off (Picture 1.B)

The receiver also contains a reset button to clear all alerts. This may be necessary when the inventions transmitters are unplugged. If there is an appliance being monitored and the transmitter is unplugged (this is not the appliance being unplugged from the transmitter but the transmitter being unplugged from the 110V outlet) then a signal cannot be sent to the receiver to turn off the light. It would be necessary to reset the lights in this case.(Picture 1.C)

The receiver contains a battery to drive all of the alert electrical functions in the receiver. In the event that the battery is running low, an alert light will be turned on allowing the user to replace the battery.(Picture 1.D)

The inventions transmitters are approximately 4″ W * 3″ H and 1″ deep Picture 2 and 3) and plug in to a 110V outlet by means of a standard grounded plug (Picture2.A and Picture 3.A). Appliances that are to be monitored are plugged in to the face of the transmitter (Picture 2.B and Picture 4.A). The transmitters simply act as a conduit for passing the 110V electrical current to the appliance and notifying the receiver. As the transmitter passes the electrical current along to the appliance, it is sends an ‘on’ wireless transmission to the receiver to turn on that transmitters light. This signal is sent every two minutes to allow for proper notification in case the receiver had been out of range.

When the current is no longer being passed through the transmitter, indicating the appliance has been turned off or unplugged, an ‘off’ wireless transmission is sent to the receiver to turn off the light for that transmitter. This signal is sent every two minutes to allow for proper notification in case the receiver had been out of range.

The transmitters can be plugged in to any 110V outlet in the house providing full flexibility on the placement of these transmitters and the appliances they will monitor. Any electrical appliance that can plug in to a 110V outlet can be plugged in and monitored by this system.

I claim:

1. A wireless transmitter and remote receiver for the purpose of notification that an electrical appliance is plugged in and on.

2. A transmitter in accordance with claim 1 that, recognizes current being passed to an appliance plugged in to the transmitter and sends a wireless signal to the remote receiver to turn on or off an alert.

3. A remote receiver in accordance with claim 1 that processes a wireless signal from the transmitter and turns on the appropriate alert indicators.

4. I claim in accordance with claim 1 a key chain that alerts users when an appliance is plugged in and turned on
